(19) United States
(12) Patent Application Publication
(10) Pub. No.: US 2020/0095761 A1
(43) Pub. Date: Mar. 26, 2020

(54) EMBEDDED NUT AND METHOD FOR MANUFACTURING THE SAME, AND CONCRETE MEMBER WITH EMBEDDED NUT

(71) Applicant: USUN (FOSHAN) TECHNOLOGY CO., LTD., Foshan (CN)

(72) Inventor: CHIU-FONG HUANG, New Taipei City (TW)

(21) Appl. No.: 16/229,335

(22) Filed: Dec. 21, 2018

(30) Foreign Application Priority Data
Sep. 25, 2018 (CN) 201811116457.3

(51) Int. Cl. E04B 1/41; B23G 9/00

(52) U.S. Cl. CPC E04B 1/4121; F16B 37/122; B23G 9/005

(57) ABSTRACT

An embedded nut for fast construction purposes comprises a connecting portion and two nut portions located at two opposite ends of the connecting portion. One end of the nut portion away from the connecting portion defines a nut hole, and the connecting portion protrudes outward in a direction away from a central axis of the two nut portions. Methods for manufacturing the embedded nut and for manufacturing a concrete member with the embedded nut are also provided.

### FIELD

The disclosure generally relates to embedded nuts.

### BACKGROUND

Modern architecture is developing in the direction of rapid construction and diversification of functions. Screw-ready reserved holes in concrete members meet the needs of rapid construction techniques and diversification of functions of architectures.

### BRIEF DESCRIPTION OF THE DRAWINGS

Many aspects of the present disclosure can be better understood with reference to the drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is a cross-sectional view of part of a concrete member in accordance with an embodiment of the present disclosure.

FIG. 2 is an isometric view of an embedded nut of the concrete member as shown in FIG. 1.

FIG. 3 is a top view of the embedded nut as shown in FIG. 2.

FIG. 4 is a cross-sectional view of part of a semi-precast concrete member in accordance with an embodiment of the present disclosure.

FIG. 5 is a perspective view of the embedded nut in accordance with another embodiment of the present disclosure.

FIG. 6 is a flow chart of a method for manufacturing the concrete member in accordance with an embodiment of the present disclosure.

FIG. 7 is a flow chart of a method for manufacturing the embedded nut in accordance with an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as coupled, whether directly or indirectly through intervening components, and is not necessarily limited to physical connections. The connection can be such that the objects are permanently coupled or releasably coupled. The term “comprising” when utilized, means “including, but not necessarily limited to”; it specifically indicates open-ended inclusion or membership in the so-described combination, group, series, and the like.

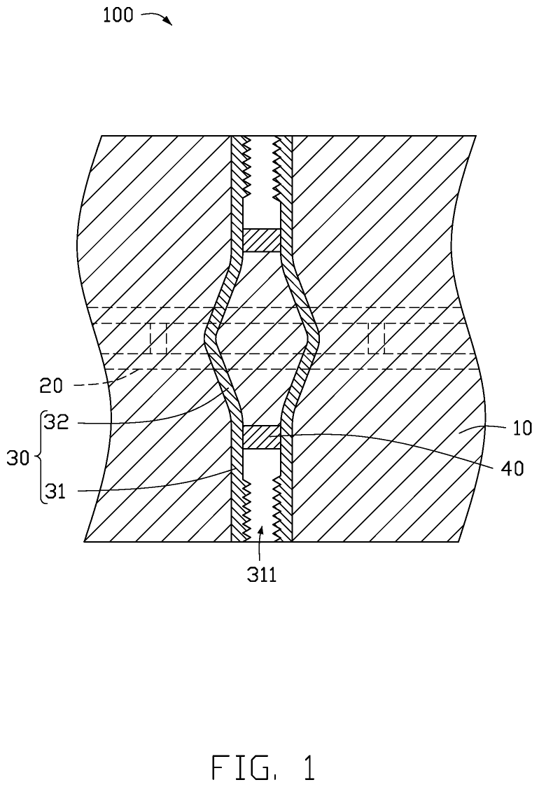

FIG. 1 shows a concrete member 100 as an embodiment of the present disclosure. The concrete member 100 can include a body 10, a frame 20, a plurality of embedded nuts 30, and a plurality of blocking pieces 40.

The concrete member 100 can be a floor slab or other modular member such as a wall, a beam, and the like. The plurality of embedded nuts 30 provides screw-ready reserved holes in the concrete member 100 for quick assembly and versatility, so as to meet the needs of rapid construction and diversification of functions of architectures.

In this embodiment, the body 10 is infused by concrete. The frame 20 is disposed in the body 10. Each of the plurality of embedded nuts 30 is disposed in the body 10 and has two ends located on two opposite surfaces of the body 10. Each of the two blocking pieces 40 is disposed in one embedded nut 30.

The body 10 can be made in different shapes and sizes as needed. The frame 20 can be made of steel and can be designed according to strength requirements of the concrete member 100. The frame 20 can be a mesh structure formed by cross-welding or bundling of two-way steel bars.

In this embodiment, the embedded nut 30 is made of stainless steel. In other embodiments, the embedded nut 30 can be made of other hard materials such as cast iron or copper.

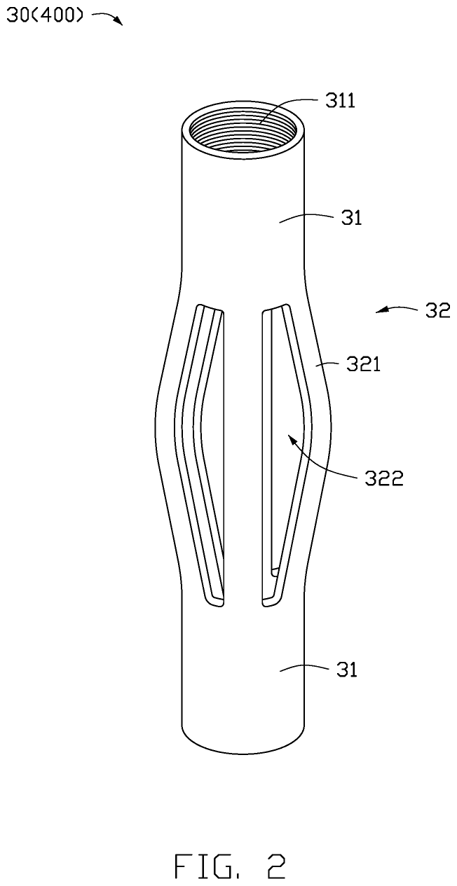

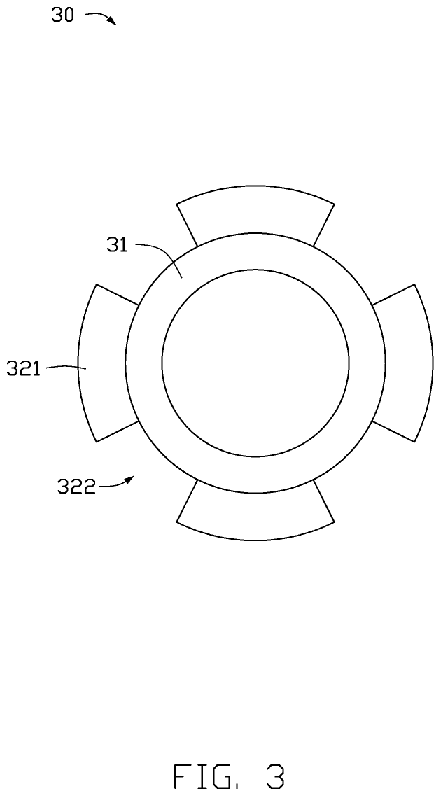

As shown in FIG. 2 and FIG. 3, each of the plurality of embedded nuts 30 can include two nut portions 31 and a connecting portion 32, the two nut portions 31 are located at two opposite ends of the connecting portion 32. The connecting portion 32 is disposed in the body 10. One end of each of the two nut portions 31 away from the connecting portion 32 defines a nut hole 311. The nut hole 311 is located on the surface of the body 10 and serves as the reserved hole for the concrete member 100.

The connecting portion 32 protrudes outward in a direction away from a central axis of the two nut portions 31 and is configured to increase the mechanical strength of the embedded nut 30 in the concrete member 100.

The connecting portion 32 may include a plurality of connecting segments 321. The connecting segments 321 are arranged along a circumference direction of the two nut portions 31 and spaced apart from each other. A middle part of each of the connecting segments 321 protrudes outward in a direction away from the central axis of the two nut portions 31.

A fixing hole 322 is defined between two adjacent connecting segments 321. The frame 20 can pass through the fixing hole 322, and the connecting segment 321 and the frame 20 can be connected by bundling or welding to facilitate the position of the embedded nut 30 when molding the body 10 in concrete.

In this embodiment, the embedded nuts 30 are arranged in predetermined positions in the body 10 in accordance with a predetermined design to form reserved holes on two opposite surfaces of the concrete member 100. The embedded nuts 30 are threaded into the frame 20 to secure the position of the embedded nut 30 in the body 10. Each of the blocking pieces 40 is located in one end of the nut portion 31 adjacent to the connecting portion 32 to prevent concrete from entering the nut hole 311 during molding the body 10.

The embedded nut 30 can be formed by cutting at least two slits in the middle of a pipe 400 and pressing two ends of the pipe 400. The pipe 400 can be pressed according to a thickness of the concrete member 100 so that a distance between the two ends of the embedded nut 30 is equal to the thickness of the concrete member 100. The pipe 400 can have a shape of cylinder or prism.

In this embodiment, the nut portion 31 has a shape of cylinder. In other embodiments, the nut portion 31 can have a shape of prism such as quadrangular prism, pentagonal prism, or hexagonal prism.

In this embodiment, the nut portion 31 has a smooth outer surface. In other embodiments, the outer surface of the nut portion 31 can have protrusions such as annular protrusions, triangular protrusions or irregular protrusions, to increase gripping effect of the nut portion 31 in the concrete member 100.

In this embodiment, the connecting portion 32 has four connecting segments 321 and four fixing holes 322. In other embodiments, a number of the connecting segments 321 and the fixing holes 322 can be three, five, or six.

In this embodiment, the blocking piece 40 is made of stainless steel. In other embodiments, the blocking piece 40 can be made of other hard material such as cast iron or copper.

In this embodiment, the blocking piece 40 has a shape of cylinder and the blocking piece 40 is selected in accordance with the size of aperture of the nut hole 311. Each of blocking piece 40 and the embedded nut 30 are screwed through the nut hole 311. The blocking piece 40 can be threadedly connected to the nut hole 311 by a thread in the nut hole 311. In other embodiments, the blocking piece 40 can by fixedly coupled to the nut portion 31 by means of snap protrusions.

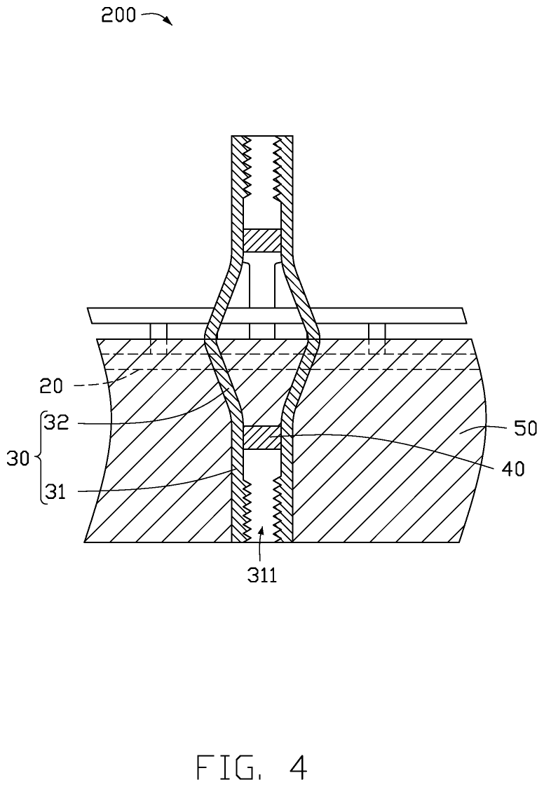

FIG. 4 shows a semi-precast concrete member 200. The semi-precast concrete member 200 can be directly poured into concrete at construction site to form the concrete member 100 as shown in FIG. 1.

The semi-precast concrete member 200 is similar to the concrete member 100 as shown in FIG. 1, except that the semi-precast concrete member 200 includes a concrete layer 50 instead of the whole body 10 infused by concrete. The frame 20 is partially disposed in the concrete layer 50 and the remaining portion of the frame 20 exposed to the surface of the concrete layer 50. One end of the embedded nut 30 is located on the surface of the concrete layer 50 away from the frame 20.

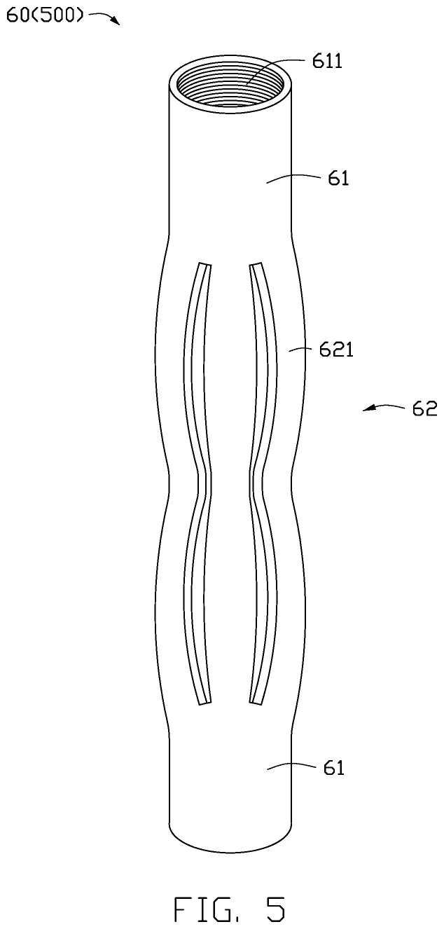

FIG. 5 shows an embedded nut 60 in accordance with another embodiment of the present disclosure. Similar to the embedded nut 30 as shown in FIG. 2, the embedded nut 60 as shown in FIG. 5 also includes two nut portions 61 and a connecting portion 62. The two nut portions 61 are located at two opposite ends of the connecting portion 62. One end of each of the two nut portions 61 away from the connecting portion 62 defines a nut hole 611. The connecting portion 62 includes connecting segments 621. Each of the connecting segments 621 has a double arch shape.

The embedded nut 60 is obtained by cutting at least two slits in the middle of a pipe 500, and then fixing the middle of the pipe 500 and pressing two ends of the pipe 500, so that each of the connecting segments 621 exhibits a double arch shape.

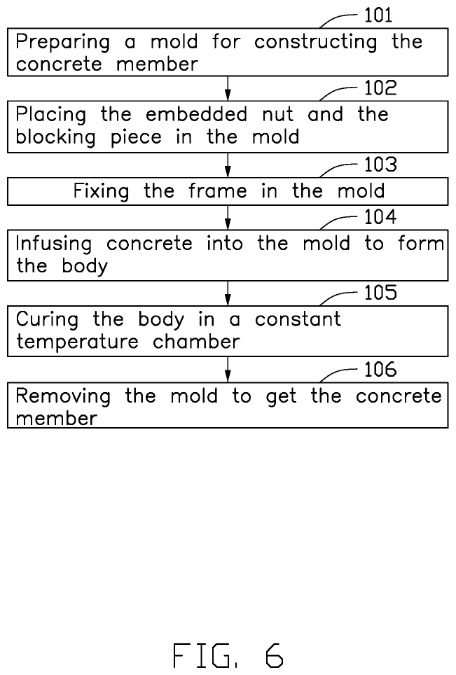

FIG. 6 shows a method for manufacturing the concrete member 100, including at least the following blocks:

S101: preparing a mold for constructing the concrete member 100;

S102: placing the embedded nut 30 and the blocking piece 40 in the mold, wherein the blocking piece 40 is located in the nut portion 31 of the embedded nut 30;

S103: fixing the frame 20 in the mold;

S104: infusing concrete into the mold to form the body 10;

S105: curing the body 10 in a constant temperature chamber; and

S106: removing the mold to obtain the concrete member 100.

Specifically, in block S101, the mold can be spliced into a certain size according to actual construction needs.

Specifically, in block S102, the number and the arrangement of the embedded nuts 30 are determined according to the actual construction needs. The nut hole 311 of the embedded nut 30 is located on the surface of the body 10 and serves as the reserved hole for the concrete member 100.

Specifically, in block S103, the frame 20 and the embedded nut 30 are connected by bundling or welding to define the embedded nut 30.

Specifically, in block S104, when the concrete is poured into the mold, the concrete is continuously stirred, so that the concrete fully fills the mold.

Specifically, in block S105, the concrete member 100 and the mold are placed in a constant temperature chamber and watered daily for maintenance.

It should be noted that the block S102 and the block S103 can be interchanged.

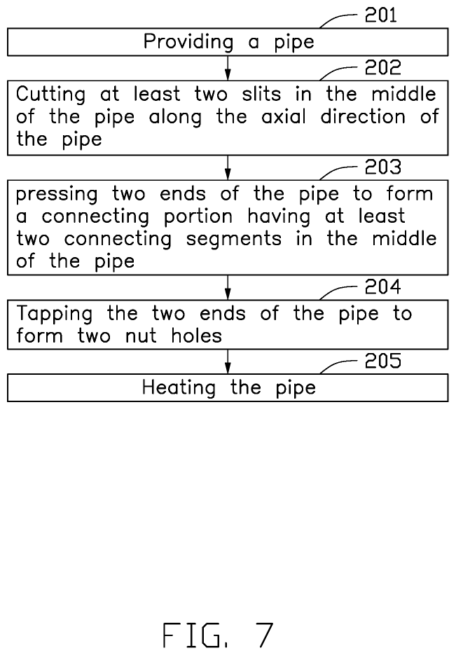

FIG. 7 shows a method for manufacturing the embedded nut 30, including at least at least the following blocks:

S201: providing a pipe 400;

S202: cutting at least two slits in the middle of the pipe 400 along the axial direction of the pipe 400;

S203: tapping threads into two ends of the pipe 400 to form two nut holes 311;

S204: pressing two ends of the pipe 400 to form a connecting portion 32 having at least two connecting segments 321 in the middle of the pipe 400; and

S205: heating the pipe 400.

Specifically, in block S201, the length of the pipe 400 and the thickness of the pipe 400 wall are determined according to actual construction needs.

Specifically, in block S202, a laser cutting device can be used for cutting the middle of the pipe 400.

Specifically, in block S203, a tapping machine can be used for tapping a thread into the nut hole 311.

Specifically, in block S204, mechanical strength of the pipe 400 can be improved by a heat treatment process such as carburizing.

It should be noted that the block S204 can be performed before the block S202.

It is to be understood, however, that even through numerous characteristics and advantages of the present disclosure have been set forth in the foregoing description,

Page 10 of 17 together with details of assembly and function, the disclosure is illustrative only, and changes may be made in details, especially in the matters of shape, size, and arrangement of parts within the principles of the disclosure to the full extent indicated by the broad general meaning of the terms in which the appended claims are expressed.

1. An embedded nut, comprising a connecting portion and two nut portions located at two opposite ends of the connecting portion, wherein one end of the nut portion away from the connecting portion defines a nut hole, and the connecting portion protrudes outward in a direction away from a central axis of the two nut portions.

2. The embedded nut as claimed in claim 1, wherein the connecting portion comprises a plurality of connecting segments, and the connecting segments are arranged along a circumference direction of the two nut portions and spaced apart from each other.

3. The embedded nut as claimed in claim 2, wherein a middle part of each of the plurality of connecting segments protrudes outward in a direction away from the central axis of the two nut portions.

4. The embedded nut as claimed in claim 1, wherein the embedded nut is made of stainless steel, cast iron, or copper.

5. The embedded nut as claimed in claim 1, wherein the nut portion has a shape of cylinder or prism.

6. The embedded nut as claimed in claim 4, wherein a plurality of protrusions are formed on an outer surface of the nut portion.

7. A method for manufacturing an embedded nut, comprising:
cutting at least two slits in the middle of a pipe along the axial direction of the pipe; and
pressing two ends of the pipe to form a connecting portion comprising at least two connecting segments in the middle of the pipe.

8. The method as claimed in claim 7, wherein the method further comprises tapping threads into two ends of the pipe to form two nut holes after forming the connecting portion in the middle of the pipe.

9. The method as claimed in claim 7, wherein the method further comprises tapping threads into two ends of the pipe to form two nut holes before cutting slits in the middle of the pipe.

10. The method as claimed in claim 7, wherein the method further comprises heating the pipe after pressing two ends of the pipe.

11. A concrete member, comprising:
a body infused by concrete; and
at least one embedded nut disposed in the body,
wherein the at least one embedded nut comprises a connecting portion and two nut portions located at two opposite ends of the connecting portion, one end of the nut portion away from the connecting portion defines a nut hole, and the connecting portion protrudes outward in a direction away from a central axis of the two nut portions; and
wherein the nut hole is located on the surface of the body; the connecting portion comprises a plurality of connecting segments, and the connecting segments are arranged along a circumference direction of the two nut portions and are spaced apart from each other.

12. The concrete member as claimed in claim 11, wherein the concrete member further comprises a frame disposed in the body.

13. The concrete member as claimed in claim 11, wherein the concrete member further comprises a plurality of blocking pieces, and each of the plurality of blocking pieces is located in one end of the nut portion adjacent to the connecting portion.

14. (canceled) .

15. The concrete member as claimed in claim 11, wherein a middle part of each of the plurality of connecting segments protrudes outward in a direction away from the central axis of the two nut portions.

16. The concrete member as claimed in claim 11, wherein the embedded nut is made of stainless steel, cast iron, or copper.

17. The concrete member as claimed in claim 11, wherein the nut portion has a shape of a cylinder or a prism.

18. (canceled) .

19. The concrete member as claimed in claim 13, wherein each of the plurality of blocking pieces and the embedded nut are screwed through the nut hole, each of the plurality of blocking pieces is threadedly connected to the nut hole by a thread in the nut hole.
